(19) United States
(12) Patent Application Publication
(10) Pub. No.: US 2002/0083088 A1
(43) Pub. Date: Jun. 27, 2002

(54) Internet transfer of financial documents

(76) Inventors: Joe Gundy, Boise, ID (US); Richard Yetsko SR., Boise, ID (US)

Correspondence Address: PEDERSEN & COMPANY, PLLC, P.O. BOX 2666, BOISE, ID, 83701, US

(21) Appl. No.: 09/990,591

(22) Filed: Nov. 21, 2001

Related U.S. Application Data
(60) Provisional application No. 60/252,302, filed on Nov. 20, 2000.

(51) Int. Cl. G06F 15/00

(52) U.S. Cl. 707/500

(57) ABSTRACT

The present invention is a system and method for transferring complete financial documents over the Internet. In the transfer process, no participation of any bank is required. According to the system of the invention, two users, the “payor” and the “payee”, each have access to the Internet, the payee needing a printer to print the financial document. A third party, the “transfer agent” has a database and e-mail capability, also with access to the Internet. The database permits the payor to send, for example, an authorization for a check from the payor's checking account to the payee at any valid e-mail address. According to the method of the invention, first the payor accesses the transfer agent's website, and, while there, authors, for example, a check in the customary manner. Then, the transfer agent's database generates a unique authorization number for the transaction as authored by the payor, the transaction number being e-mailed to the payee. The payee, when it accesses the e-mail message, hyperlinks to a webpage of the transfer agent that provides use of the e-mailed authorization number. Then, the database publishes to the payee a webpage in the format of an appropriate check as authored by the payor, including standard optical character recognition (OCR) font. Then, the payee can print the published webpage as a complete check from the payor.

### DESCRIPTION

This application claims priority of our prior, co-pending provisional patent application, Serial No. 60/252,302, filed on Nov. 20, 2000, which is incorporated herein by reference.

### BACKGROUND OF THE INVENTION

1. Field of the Invention

Generally, this invention pertains to finance and financial transactions. More specifically, this invention pertains to transferring financial documents, especially commercial paper, including checks, over the Internet.

2. Related Art

Online payment systems for the Internet have been available for some time. Typically, however, these online systems require the intermediate participation of bank computer systems. See, for example, the NetCheque system described in Information Today, Volume 12, Issue 3, Page 43 (March 1995). See also U.S. Pat. No. 6,070,150 (Remington et al.)

However, there is still a need for a quick and easy system for transferring financial documents over the Internet, without the intermediate participation of any bank. That is to say, there is still a need for an Internet system which permits one user to transfer directly to another user a complete financial document without the participation in the transfer by any bank. This invention addresses that need.

### SUMMARY OF THE INVENTION

The present invention is a system and method for transferring complete financial documents over the Internet. In the transfer process, no participation of any bank is required.

According to the system of the invention, two users, the “payor” and the “payee”, each have access to the Internet, the payee needing a printer to print the resulting financial document.

A third party, the “transfer agent” has a database and e-mail capability, also with access to the Internet. Preferably, the database is an SQL (Structured Query Language) database that permits the payor to send, for example, an authorization for a check from the payor's checking account to the payee at any e-mail address.

According to the method of the invention, first the payor accesses the transfer agent's website, and, while there, authors, for example, a check in the customary manner. Then, the transfer agent's database generates a unique authorization number for the transaction as authored by the payor, the transaction number being e-mailed to the payee. The payee, when it accesses the e- mail message, hyperlinks to a webpage of the transfer agent that provides use of the e-mailed authorization number. Then, the database publishes to the payee a webpage in the format of an appropriate check as authored by the payor. The published check includes standard optical character recognition (OCR) font, so that it can be handled as an ordinary check by banks. The OCR font is provided by the transfer agent's database, independently of the payor or payee's specific application programs running on their Internet access computers. Then, the payee can print the published check from the webpage as a complete check from the payor.

The transfer agent can charge a fee for each use of the system and method. Or, the transfer agent can charge a subscription fee for repeated use over a specific time period.

### BRIEF DESCRIPTION OF THE DRAWINGS

FIG. 1 is a schematic depiction of one embodiment of the system of the present invention, showing its component parts and their interconnections.

FIG. 2 is a schematic depiction of one embodiment of the method of the present invention, showing its component steps.

### DESCRIPTION OF THE PREFERRED EMBODIMENTS

Referring to the Figures, there are depicted one embodiment, but not all embodiments, of the present invention.

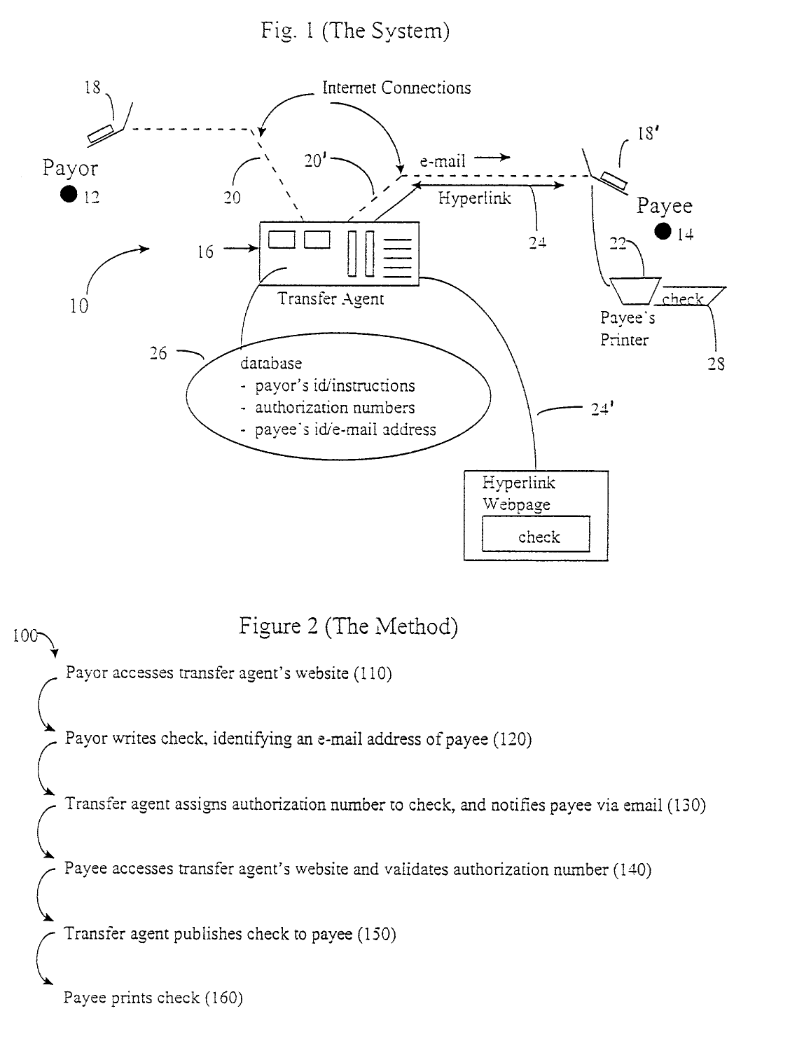

In FIG. 1 is depicted a schematic diagram of the system 10 of the present invention. The system comprises facilities, for example, a station for a payor 12, a station for a payee 14 and a station for a transfer agent 16. The payor 12 and the payee 14 both have access to the Internet, indicated by Internet connections 18 and 18′. Transfer agent 16 has access via the Internet to both the payor 12 and the payee 14, indicated by connections 20 and 20′, respectively. Payee 14 also has access to a printer 22, so payee can print a financial document sent to it from payor.

Transfer agent 16 has Internet e-mail capability effective through connections 18′ and 20′ to payee 14. Preferably, connection 20′ between transfer agent 16 and payee 14 has a hyperlink connection 24 for the convenience and speed of the payee. A schematic depiction of the hyperlink is depicted at item 24′. Also, transfer agent 16 has database capability 26. Database 26 can contain information relating to payor's I.D. and instructions, as well as the authorization number for the specific financial transaction between payor 12 and payee 14. Also, database 26 can contain information relating to payee's I.D. and e-mail address. Therefore, indices and fields that would be included in database 26 include, for example: the payor station's identity and payor station's instructions for the financial document directed to the payee station; a unique authorization code identified to the payor station's instructions for the financial document; and payor station's identification and Internet e-mail address. In addition, database 26 contains optical character recognition (OCR) font as dominant default images in graphic interface files (GIF's). This way, the database can contain all the information necessary for the financial transaction between payor and payee, resulting in this case in check 28 being printed from payee's printer 22.

Also, this way, check 28 contains standard optical character recognition (OCR) font, so that it can be handled as an ordinary check by banks. In the transfer agent's database 26 are the OCR numerals 1-10 and OCR letters A-E as graphic interface files (GIF's). These GIF's are programmed by conventional techniques to be dominant default images so that they will be published to payee 14 and printed on check 28, regardless of the specific application programs running on payor or payee's Internet access programs. The financial document may be depicted at both the payor station and the payee station as conventional checks. Also, as an added feature, the transfer agent's database may keep a checking account register for the payor, and depict it conventionally as such at the payor station.

In FIG. 2 is depicted a schematic diagram of the method 100 of the present invention. According to the method 100; first in step 110 the payor 12 accesses transfer agent's 16's website. Then, in step 120, while at transfer agent's website, payor authors a check in the customary manner, namely with payee's name, the date, the payor's bank number and check number, the amount of the check, payor's signature and, additionally in the case of this invention, the e-mail address of the payee.

Then, in step 130, transfer agent 16 intakes payor's information and instructions, assigns a unique authorization number to the transaction, and notifies the payee 14 by e-mail of the check being available for payee from payor. When, in step 140, payee accesses the transfer agent's website, payee receives the authorization number provided by the transfer agent. Upon request by payee who uses the authorization number, transfer agent in step 150 publishes the check authored by payor to payee. Then in step 160, payee prints the check authored by payor, thereby receiving a complete and effective financial document, including with the standard OCR font, without the intermediate participation by any bank.

Also, conventional encryption techniques may be employed to preserve privacy and security in the practice of the present invention. In addition, conventional precautionary steps may also be taken to prevent embezzlement or fraud. Also, conventional automatic techniques for identifying and correcting errors on the part of the payor or payee in completing their transaction via practice of the present invention may also be employed.

Although this invention has been described above with reference to particular means, materials and embodiments, it is to be understood that the invention is not limited to these disclosed particulars, but extends instead to all equivalents within the scope of the foregoing description and the following claims.

We claim:

1. A system for transferring financial documents over the Internet comprising:
a payor station with an Internet connection;
a payee station also with an Internet connection, and with a printer;
a transfer agent station connectable over the Internet to both said payor station and said payee station, said transfer agent station having a database containing:
payer station's identity and payor station's instructions for a financial document directed to said payee station;
a unique authorization code identified to said payor station's instructions for said financial document; and,
payee station's identification and Internet e-mail address;
so that said payee station can print said financial document according to said payor station's instructions as identified by said unique authorization code.

2. The system of claim 1 wherein said transfer agent station is not a bank.

3. The system of claim 1 wherein said database is an Structured Query Language (SQL) database.

4. The system of claim 1 wherein the payee station's Internet connection is a hyperlink connection.

5. The system of claim 1 wherein said financial document, when printed, contains standard optical character recognition (OCR) font.

6. The system of claim 5, wherein said optical character recognition (OCR) font is present as dominant default images in graphic interface files (GIF's) in said transfer agent station database.

7. A method for transferring financial documents over the Internet, the method comprising:
a payor station accessing a transfer agent's website, authoring a financial document at said transfer agent's website, and identifying an e-mail address of a payee;
said transfer agent assigning an authorization code to said financial document, and notifying said payee via e-mail of the existence of said financial document and said authorization code;
said payee accessing a website of said transfer agent, and, via said authorization code, printing said financial document.

8. The method of claim 7 wherein said financial document is a check.

9. The method of claim 7 wherein said transfer agent is not a bank.

10. The method of claim 7 wherein said payee accesses a website of said transfer agent via a hyperlink Internet connection.

11. The method of claim 7 wherein said printing of said financial document results in optical character recognition (OCR) font.

12. The method of claim 11 wherein said optical character recognition (OCR) font results from dominant default images in graphic interface files (GIF's) in a database at a website of said transfer agent.
